(19) United States
(12) Patent Application Publication
(10) Pub. No.: US 2008/0109412 A1
(43) Pub. Date: May 8, 2008

(54) SYSTEM AND METHOD FOR COMMUNITY-BASED NEEDS FOR COMMUNICATION AND FULFILLMENT

(76) Inventors: Jay A. Drayer, Houston, TX (US); Grant M. Howe, Cypress, TX (US)

Correspondence Address: FULBRIGHT & JAWORSKI, LLP, 1301 MCKINNEY, SUITE 5100, HOUSTON, TX, 77010-3095, US

(21) Appl. No.: 11/923,253

(22) Filed: Oct. 24, 2007

Related U.S. Application Data
(60) Provisional application No. 60/862,702, filed on Oct. 24, 2006.

(51) Int. Cl. G06F 7/06

(52) U.S. Cl. 707/3; 707/E17.108

(57) ABSTRACT

At least one aspect of this invention relates to a system and method for providing an online community by which subscribers communicate one or more need requests, arising from personal catastrophe or medical illness, to a plurality of members of the online community, who offer to fulfill the user's need though on-system processes and off-system actions. The system preferably providing to the community members content relevant to fulfilling the user's need, together with the need request.

### CROSS-REFERENCE TO RELATED APPLICATIONS

The present application claims priority to U.S. Provisional Patent Application Ser. No. 60/862,702, filed Oct. 24, 2006, which is incorporated by reference herein in its entirety.

### TECHNICAL FIELD

At least one aspect of this invention relates to a system and method for providing an online community. More particularly, at least one aspect of the invention relates to communicating a need request together with relevant advertising content to an online community, and receiving from one or more community members an offer to fulfill the need request.

### BACKGROUND OF THE INVENTION

When someone has a serious illness or catastrophic event happen to them, members of their support network and extended community typically offer to help. However, the offers generally take the form of “If there is anything I can do, please let me know.” For the affected person, as well as the offeror, this is often a very awkward and difficult exchange. No one wants to overstep the boundaries of good taste, and no one wants to force these types of dynamics in an inappropriate way. It is especially difficult for most people to directly ask for financial support, to ask for help for family or work-related tasks, or to just ask for in-person support at a tough time. Impediments to an otherwise functional exchange can include many of the fundamental issues of people, including ego, pride, sensitivity in not wanting to offend or put people on-the-spot, the time and effort to contact everyone, and just the uncomfortable experience of it all.

These impediments are often magnified for individuals in financial distress, a situation often arising from medical illness and personal hardship. In this context, individual's financial needs frequently surpass their own financial resources, the resources of those in their support network, and even extended community. In this circumstance, of great consequence to the individual afflicted with illness or hardship is the opportunity to share some facet of their circumstance with people that they may, but more likely do not know, in such a way as to enlist financial support.

In other contexts, online communities, such as social networking websites and web logs (“blogs”), have emerged recently as tool to cut across perceived social impediments. Informal and indirect communications via online communities, for instance, offer participants a means to engage in meaningful social exchanges, without the above mentioned social impediments and other logistical obstacles. Certain online communities also bring together investors and entrepreneurs looking for alternative ways to borrow and lend money. Still other types of online communities feature collaborative tools enabling highly fragmented community members of similar interests to cooperate in achieving specific tasks.

The problem with presently known online communities, however, is that they fail to provide tools for individuals afflicted with serious illnesses or subject to catastrophic events to reach out to their support networks and extended communities for help. In fact, presently known online communities largely ignore the needs of individuals suffering personal illness or catastrophe. At the same time, the growing subscriber base of online communities present a powerful channel through which individuals in need can reach out to vast numbers of likeminded individuals, not necessarily personally known to the user, with specific need requests. For the first time, as creative investors and philanthropists connect in online communities, their collaborative and individual efforts provide new opportunities for individuals to get help with their financial needs.

Therefore, at least one object of the present invention is to provide a system and method for online community-based need and fulfillment communication, adapted for individuals afflicted with medical illness or suffering from a catastrophic event.

### BRIEF SUMMARY OF THE INVENTION

At least one embodiment of the invention allows an individual in need and supportive members in his online community a more comfortable and effective means of communicating and fulfilling their needs. To do so, a framework is disclosed to allow an individual in need to reach out electronically, via the Internet, to members of their online community and ask for help on specific needs. In this context, community members include supportive friends, family, colleagues, congregation and other support resources. The community members listen online via web logs (“blogs”), calendar appointments, emails, texting, voice messages, etc. Community members then can respond electronically through similar means offering to fulfill the need request.

One further embodiment includes a user, with an established online support community, having a need that he hopes community members can fulfill. The user logs on to the online community and enters at least one need request. The need request might be for services, fundraising activities, money loans, information, financial support (gifts or otherwise) or any of a number of needs that may arise as a result of the user's circumstance, for example.

In a further embodiment, a community member receives notification of the need request and has the opportunity to fulfill it. Doing so, the community member logs on to the online community and enters a fulfillment offer for the need request, using a method selected by the requesting user, or another method as convenience permits. Based on the need request, the system identifies relevant displayable content, such content useful to discharge the need request. The system communicates the need request, together with relevant content, to community members for review. The system also optionally communicates relevant content to the requesting user.

Community members preferably enter a fulfillment offer, after reviewing the need request. The requesting user is notified of fulfillment offers made in response to his need request. Anonymity of the offering community member is optionally maintained.

Requesting users have the option to accept (in full or in part) and reject each fulfillment offer. Alternatively, the requesting user chooses to automatically accept the first tendered fulfillment offer, in such a way that subsequent potential offering community members receive notification of acceptance, or can lookup the status of the need request.

Accepted fulfillment offers lead to discharge of the user's need request by actions of the offering community member. Accepted fulfillment offers are also preferably processed by the system resulting in financial transactions, calendar appointments, blog postings, “million pixel page advertisements,” for pay advertisements, emails, “auction for my cause,” and recognition by the online community, for example.

In general, system processes execute the following steps: user with an established online community posts a need request to the system, selecting community members to receive the need request, and a response type. Selected community members receive notification of the new need request. Community members log on to the online community system and view the user's need request. Wanting to help, the community member chooses an appropriate response offering to fulfill the need request. The requesting user receives notification of the fulfillment offer and accepts the offer. Other community members receive notification of the status of the need request.

To implement the above and other features of the system, one embodiment of the system comprises a need request engine operable to receive a need request from a user and present the received need request to a plurality of community members of the user; and a fulfillment engine operable to receive a plurality of fulfillment offers to the need request from at least one of the plurality of community members, presenting the fulfillment offers to the user, and receiving an acceptance of the fulfillment offer by the user. Optionally, the need request engine is operable to receive a need request arising from a medical illness. The need request engine is also optionally operable to receive a need request arising from a personal catastrophe. The fulfillment engine is optionally operable to receive a fulfillment offer in the format of a fundraising activity, a money loan, one or more physical actions by the community member.

In another embodiment, the system comprises a need request engine operable to receive a need request from a user and present the received need request to a plurality of community members of the user; wherein the need request engine is operable to identify relevant content based at least in part upon said need request and present the relevant content to a plurality of community members of the user.

In another embodiment, the system also comprises a fulfillment engine operable to receive a plurality of fulfillment offers to the need request from at least one of the plurality of community members, presenting the fulfillment offers to the user, and receiving an acceptance of the fulfillment offer by the user.

In another embodiment, the system also comprises a fulfillment engine operable to receive a selection of relevant content from at least one of the plurality of community member.

In still a further embodiment, a method comprises receiving a need request from a user; setting up response types desired for the need request; formatting the need request and presenting the need request to a plurality of community members of the user; receiving a plurality of fulfillment offers to the need request from plurality of community members; receiving an acceptance of a fulfillment offer from one of the plurality of community members by the user; notifying the acceptance to the community member who offered the accepted fulfillment offer, and to the rest of the community members receiving the need request; and processing a resulting transaction of the accepted fulfillment offer.

In another embodiment, the need request is in a format selected from the group comprising of blog entries, calendar appointments, emails, text messages, and voice messages.

In another embodiment, the fulfillment offer is in a format selected from the group comprising of blog entries, calendar appointments, emails, text messages, and voice messages.

In another embodiment, the resulting transaction is in a format selected from the group comprising of financial transactions, calendar appointments, blog postings, million pixel page advertisements, for pay advertisements, emails, and auctions for my cause.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

### BRIEF DESCRIPTION OF THE DRAWINGS

FIG. 1 is a simplified block diagram of a need request engine according to an embodiment of the system for community-based needs communication and fulfillment;

FIG. 2 is a simplified block diagram of a fulfillment engine according to an embodiment of the system for community-based needs communication and fulfillment;

FIG. 3 is a flowchart of a user login and select add need request process according to an embodiment of the system for community-based needs communication and fulfillment;

FIG. 4 is a flowchart of a user login and fulfillment offer process according to an embodiment of the system for community-based needs communication and fulfillment; and

FIG. 5 is a flowchart of an acceptance process according to an embodiment of the system for community-based needs communication and fulfillment;

### DETAILED DESCRIPTION OF THE INVENTION

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. It is also understood that, for purposes of clarity, like reference numerals identify like elements, structures and processes in each of the figures. The framework disclosed herebelow is preferably implemented by a computer executable program and/or hardware, according to practices known to those of ordinary skill in the art. It is to be appreciated that the processes described herein are instances of a computer program.

The disclosed framework addresses shortcomings of present online communities by providing an innovative means to fulfill a user's need request communicated to one or more members of the online community. Doing so, the system is operable with a need user interface for populating a need request process, which executes with a need request engine to present to selected community members the need request, together with relevant content.

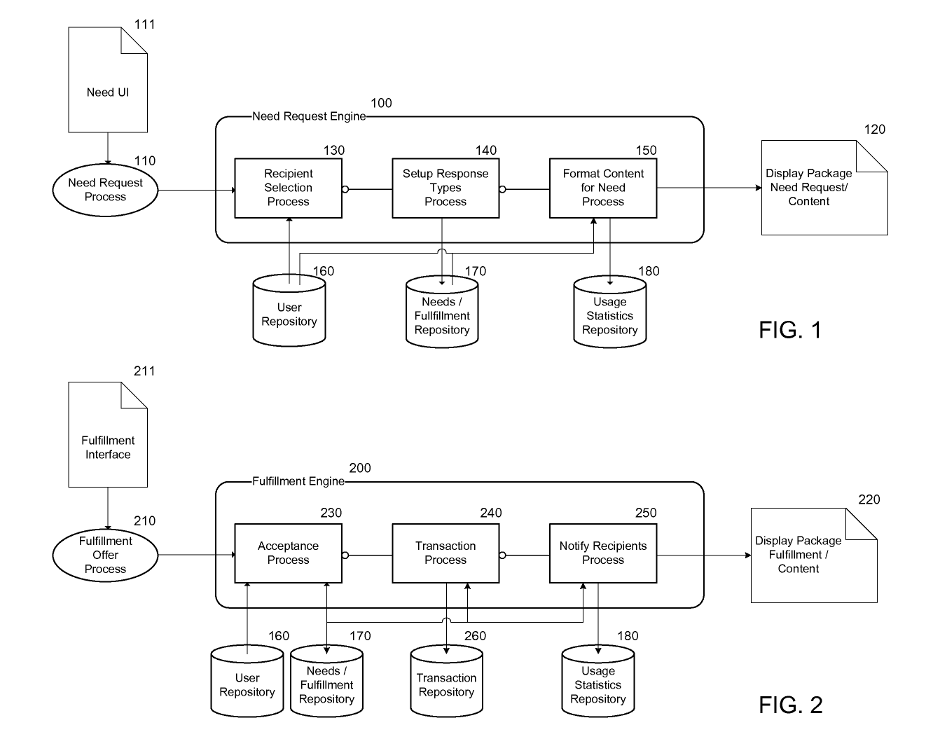

Shown in FIG. 1, the need user interface 111 provides users access to the online community to communicate with their support network, and extended community. To do so, the need user interface 111 is operable, in a known way, to receive inputs and display as outputs all manners of communication signals.

In particular, the need user interface 111 is adapted to receive inputs in a variety of formats, including web blog entries, calendar appointments, emails, text messages, voice messages, etc. Accordingly, the need user interface 111 is operable to receive inputs in formats supported by modern telecommunications devices.

Received inputs from the user couple with system processes that analyze and parse the inputs to populate the need request process 110. As needed, such processes include voice recognition software and/or call handling software to analyze and parse received voice and text messages, and scraper processes to collect user's content from web pages/blogs, calendar appointments, emails, for example.

In another embodiment, the need user interface 111 includes a web portal adapted with form templates, drop down menus, free text fields, and content upload means. For convenience of use, the web portal preferably displays a calendar, viewable by month, identifying needs for a given time/day. A need filter selectively filters needs entered in the calendar, as desired.

The user interface 111 is also optionally operable to display a list of proposed needs. The proposed list preferably includes a predefined set of actions, groups, necessities, activities, leisures, and foods, for long-term and short-term fulfillment of user needs. In further embodiments, the fulfillment interface 211 (See FIG. 2) is operable for community members to select or setup a new need descriptions to fulfill a need.

Inputs received over the need user interface 111 include user login information, need type, need description, and need properties, for example. Described below, such inputs collectively make up one or more need requests. User login inputs are generally known in the art and, as such, are not described in detail herein.

A user's need preferably arises, directly or indirectly, from a medical illness, catastrophic event, or the like. Need types describe at a high-level the general nature of the user need or circumstance.

Need types provide a title or name by which to identify a user's need within the system. Viewing the need type, community members should appreciate generally what the user needs help with.

For example, a user afflicted with an acute medical condition may lack financial resources to pay for a life-critical medical procedure. Appealing to supportive individuals in an online community for help, a need type indicates his need for “financial support,” and “medical treatment,” for example.

In the preferred embodiment, need types include, personal services, fundraising activity, loan, information, financial support, for example. It will be appreciated that other need types explaining the general nature of the user's need are provided for in alternative embodiments.

For ease of use, an interactive calendar displayable over the need user interface 111 populates with need types. The calendar preferably includes a need filter operable to selectively highlight, or otherwise draw attention to, specific need types populating the calendar. Selection of the “personal services” need type, for example, causes the need filter to display/highlight only the user's personal services needs on scheduled dates, hiding/unhighlighting other entries.

Also displayable in the calendar are need descriptions. For each need type, one or more need descriptions preferably exist.

A need description summarizes specific acts to discharge a user's need. Accordingly, the need description informs community members of one or more tasks they must complete to fulfill the user's need.

It is understood that a need description can indicate off-system and on-system acts to discharge the user's need. In this context, on-system acts invoke the transaction process 240, which executes to carry out financial transactions, million pixel page advertisements, for pay advertisements, auction for my cause, calendar appointments, blog postings, emails, etc. (See FIG. 2, and transaction process discussion below). Off-system actions, include any act outside the system by a community member, or another person to discharge the user's need. It is also understood that, community members, acting alone, or in combination with system processes, can fulfill the user's need request.

In other embodiments, off-system actions by community member and others preferably fulfill user need requests. For this purpose, the need user interface 111 is operable to receive a need description summarizing a specific action a supportive individual may perform to fulfill the user need request. For off-system actions, a need description thus includes, without limitation, performing free medical procedures, providing pro bono legal services, babysitting children, picking-up and delivering pharmaceuticals, transporting individuals in need to patient therapy/examinations, researching advocacy groups, donating time, and performing errands, etc.

To further inform the community about the user's needs, user's input need properties. For each need description, one or more associated need properties preferably exists.

Need properties provide additional details about the user's needs. Need properties thus preferably stipulate conditions or steps that should be met when performing acts indicated in a need description. Need properties include duration of the need, frequency of the need, etc.

Where as a need description indicates acts to be performed, need properties indicate when, how, where, and for how long such acts should occur. Accordingly, need properties preferably indicate days on which the act should be performed, forms of payment, duration of advertisement, how and where to donate goods and services, for example.

Need parameter thus preferably provide, in some form or fashion, a way for individuals in need to communicate the intricacies of how to discharge their need. Once input to the user interface, the need properties, together with need type and need description (collectively making up a “need request”), populate the need request process 110.

It is understood therefore that need requests arise from any source, circumstance, event, or perceived event known or unknown to the user. In particular, a need request may arise from any human necessity, or value. In the preferred embodiment, need requests arise from medical illness, personal hardship, personal catastrophe, loss of loved ones, psychological trauma, physical ailment, financial distress. Alternatively, need requests arise to form a user's desire to form or mend a relationship.

Shown in FIG. 1, The need request process 110 selectively or automatically executes to collect need requests input to the user interface 111. Once populated, the need request process 110 invokes processes of the need request engine 100.

Shown in FIG. 1, the need request engine 100 comprises three main processes: a recipient selection process 130, by which the user selects community members to receive a need request; a setup response types process 140 for users to selectively choose how to accept fulfillment offers from community members; a format need for content process 150 for packaging the user's need request and (optionally) content relevant to the user's need, for display to selected community members.

Users preferably choose which community members can view a given need request. To that end, the recipient selection process 130 is operable to receive over the need user interface 111 a selection of community members within the online community indicating who the user wishes to view his need request. A combination of user specified criteria preferably determine which community members receive the user need request including, nature of relationship (e.g., family, coworker, trusted friend), affiliations (e.g., civic organizations, advocacy groups, religious followings, etc.), and member rating (e.g., likelihood of acceptance based on member history).

In the preferred embodiment, users select community members according to their geographic location, for example. Accordingly, the recipient selection process 130 is operable to display a list of community members, sorted by postal zip code. In alternative embodiments, the recipient selection process 130 automatically selects community members to view a given need request based upon priorities predefined by system administrators.

A list of existing community members is readily available to users during the selection process, by queries to the user repository. However, users can add new recipients as desired by operation of the recipient selection process 130.

The user repository 160 preferably stores a listing of all community members and pertinent community member information. When queried, stored data populates the recipient selection process 130. Accordingly, the user repository 160 is preferably a digital storage medium adapted with a database of a known sort, having a structured collection of records for storage of the community member list and related information. As with known databases, the stored records and data preferably include an indexing means to enable faster queries.

Administrators, third parties, and system processes preferably populate the user repository 160 with community members' information collected during member sign-up and data mining processes. Both online and offline interests of community members populate the user repository 160. Collected information include the community members' memberships to online forums or websites, personal or educational experiences, online likings or habits such as web sites visited, spending, gifts received, foods, manner of exercise, and blog entries, for example. Based in part upon information stored in the user repository 160, the format content for need process 150 is operable to serve advertising and topic content to community members, as discussed below.

Before doing so, the user preferably indicates how a fulfillment offer is be accepted. Users enter their preferred method of acceptance via the setup response type process.

Accordingly, the setup response type process 140 is operable to provide a plurality of response types including: auto-accept, open request, and bid-ask, for example. Users preferably select one or more of such response types for each need request entered, specifying the manner by which they wish to accept a fulfillment offer.

Auto-accept response types automatically accept fulfillment offers received from a community member. Under the auto-accept response type, the first received fulfillment offer is accepted. As desired, users set up the auto-accept response as an open request, which accepts and continues to accept received fulfillment offers, in instances where multiple offers are desired.

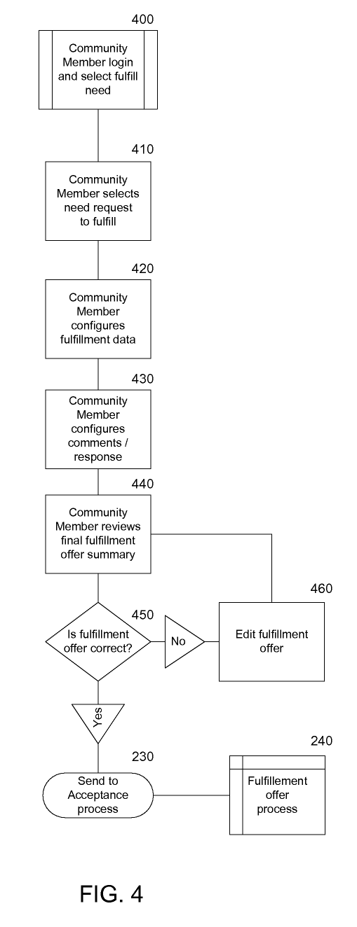

Bid-ask response types present fulfillment offers to the user for review prior to their acceptance. Under the bid-ask response type, users review the fulfillment offer and other data entered by the community member and accept in full or in part. Offering community members can review a user's partial acceptance, then accept or decline, repeating the process as necessary. (See FIG. 4).

The setup response types process 140 stores user need requests, a selection of community members, and response types to the needs and fulfillment repository 170. There, such information is accessible by system processes as needed.

The needs and fulfillment repository 170 is preferably a digital storage medium adapted with a database of a known sort. As noted, the needs and fulfillment repository 170 preferably stores need requests, a selection of community members, and response types. The needs and fulfillment repository also stores fulfillment offers entered by selected community members, including inputs such as fulfillment data, fulfillment comments, and any other information input by the community member in response to a need request.

When queried, the needs and fulfillment repository 170 provides stored information as inputs to system processes, including the setup response types process 140, acceptance process 230, transaction process 240 and notify recipients process 250. Those of skill in the art will appreciate that, as needed for system efficiency, other system processes, including the format content for need process 150, also store and retrieve data from the needs and fulfillment repository 170.

The format content for need process 150 is operable to (i) format need requests for display, and optionally (ii) identify and format content relevant to such need request, for delivery to selected community members. Means for formatting such information include creating a content file and metadata, which are generally known in the art, and as such, not discussed in detail here. In a similar way, the format content for need process create a content package comprised of need requests and/or relevant content.

Because community member tendencies may differ, the format content for need process 150 preferably identifies different content for each community member. The content identified for one community member may thus include treatment or therapy options, including links to advocacy groups, articles from distinguished therapists, special offers for pharmaceuticals, invitations to join support groups, etc. At the same time, content packaged for another community member may include advertising content for products and services useful to discharge the user need request, including links to wire transfer services, advertising services, auction for my cause services, local children's activities, cleaning services, property management services, and restaurants, for example.

For improved accuracy in identifying relevant content, the format content for need process 150 executes to collect user and community member inputs, matching such inputs to content likely to be of interest the viewer. The format content for need process 150 also preferably executes queries to the user repository 160, and external sources of community member created content, to collect information useful in identifying relevant content. The format content for need process 150 systematically parses such content and user need requests, collecting keywords to help identify relevant content.

In this context, one manner of identifying relevant content is disclosed in U.S. patent application Ser. No. 11/861,068, by Jay Drayer and Grant M. Howe, filed Sep. 25, 2007 (hereinafter the '068 App.), hereby incorporated by reference in its entirety. In a similar manner to the disposition engine of FIG. 1 and content generation engine of FIG. 2 described in the '068 App., the format content for need process 150 executes to collect and analyze keyword and other types of information supplied by users/community members to the system. The format content for need process 150 also identifies relevant content based on uniform codes or terms. Doing so, the format content for need process 150 queries the user repository 160, and need and fulfillment repository 170, matching uniform codes/terminology with stored information. Matched codes help to identify relevant content, as described in the '068 App.

In a known way, the content package and need request process 150 format the content and/or the need request into a display package 120. After delivery of the display package 120, the format content for need process 150 executes to collect feedback information for the delivered content and/or need requests.

The usage statistics repository 180 stores feedback information. Feedback information preferably includes information such as name of requesting user, and when the need request was viewed by a community member, for example. Feedback information also includes accounting and invoicing information, such as content clicks, cost per click, visits, cost per visit, click-through rates, and evidence of click fraud. Feedback information provides inputs to system and external processes for data mining of user and community member information.

As noted, the display package 120 presents to community members a user's need requests, simultaneously with relevant content. In a known way, the fulfillment interface 211 displays the content package 120 to community members. In the preferred embodiment, community members view the display package over email, text and voice messages, calendar appointments, blog entries, for example.

Therefore, by cooperation of processes in the need request engine 100, the display package 120 preferably presents at least one user need request and highly relevant content, customized to each community member. By displaying user need requests together with relevant content, via the fulfillment interface, community members have access to both information about friends and family in need, and a means to effect fulfillment of such needs.

Shown in FIG. 2, the fulfillment interface 211 is operable in substantially the same manner as the need user interface 111, the description of which is incorporated by reference to this section for purposes of brevity. By use of the similar processes and structures, it is to be understood by those of skill in the art that the fulfillment interface 211 provides community members access the system in the same manner that the need user interface 111 provides users access to the system.

As noted, the fulfillment interface 211 presents to community members the display package 120, formatted with one or more user need requests and relevant content. Accordingly, the fulfillment interface 211 is operable receive and process requests for linked content (e.g., advertising, articles, information, etc.). The fulfillment interface 211 is also operable to receive fulfillment offers.

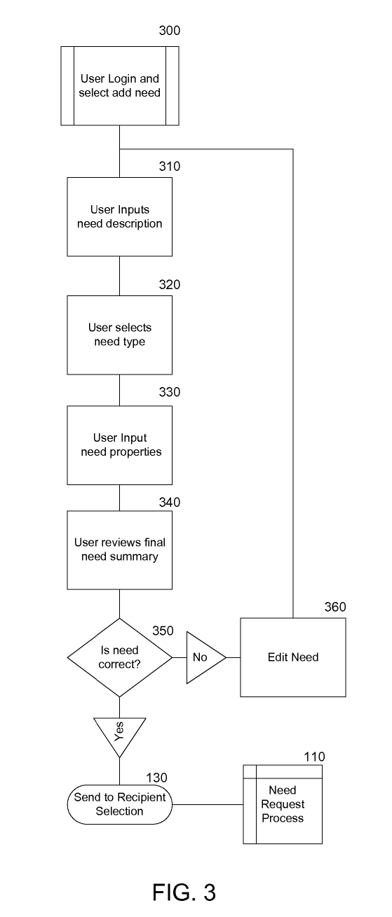

A fulfillment offer includes a plurality of information responsive to a need request. In particular, a fulfillment offer includes a selection of one or more need requests that the community member wishes to fulfill, fulfillment data, and/or fulfillment comments, etc. (See FIG. 3).

It is noted that the fulfillment offer may be made in the format of any act on the user's behalf. Fulfillment offers may be in the format of an act to discharge all or a portion of the user's need. Fulfillment offers can also be in the format of any act pertinent to discharging a user's need, such needs arising from a circumstance, event, a perceived event known or unknown to the user, human necessity, or value, medical illness, personal hardship, personal catastrophe, loss of loved ones, psychological trauma, physical ailment, financial distress, relationships, etc. In the preferred embodiment, fulfillment offers are made in the format of a fundraising activity, money loan, physical activities, auction for my cause, monetary gifts, acts of kindness, laundry, cooking, childcare, transportation, research, information, charitable donations, travel arrangements, and the like.

Community members agree to fulfill a user's need request by selecting a need request. Inputting fulfillment data, the community member provides information responsive to the need request, preferably indicating how the community member will discharge the selected need request. Fulfillment data may thus indicate that the community member will provide a monetary gift to pay for a medical procedure, for example. Fulfillment data may also indicate that the community member will carry out a fundraising activity such as, a million pixel page advertisement, for pay advertisement, and/or auction for my cause, for example. Fulfillment data may also indicate that the community member will enter a financial transaction, such as a loan for money, or a monetary gift. Fulfillment data may also indicate that the community member will complete specific off-system actions to discharge the user's need request. Such actions may include, providing childcare coverage on a particular day, laundering cloths, driving the individual in need to therapy, for example.

Community member enter comments to indicate how, when, how often, and where they will perform acts discharging the user's need. Community member may also make further inquiry about the need request, or seek to modify the need request. For these reasons, the fulfillment interface is operable to receive comments, indicating specific acts, requesting information, or proposing changes. Comments may provide that certain actions can be completed, but others not, for example.

It is therefore noted that requests for content (advertising, articles, information, etc.) and fulfillment offers (e.g., selection of need requests, fulfillment data comments) enter the system via the fulfillment interface 211, populating the fulfillment offer process 210. The fulfillment offer process 210 selectively or automatically executes to collect community member inputs to the fulfillment interface 211. Once populated, the fulfillment offer process 210 invokes processes of the fulfillment engine 200 described in FIG. 2.

Shown in FIG. 2, the fulfillment request engine 200 comprises three main processes: an acceptance process 220, by which the community members offer to fulfill a user's need request and provide notification of same; a transaction process 140 for recording the fulfillment offer and invoking process executable to discharge all or a portion of the need request; a notify recipients process 250 for packaging the fulfillment offer and relevant content, displayable to the requesting user.

The acceptance process 230 processes fulfillment offers entered by community members. Requesting users optionally review fulfillment offers prior to acceptance, as indicated by the need request response type (e.g., auto-accept, bid ask, etc.).

In this context, the acceptance process 230 is operable to automatically accept fulfillment offers, or notify a requesting user that a fulfillment offer was entered. The requesting user can view fulfillment offers, including fulfillment data and fulfillment comments, over the user interface 111. By operation of the acceptance process 230, the requesting user accepts or declines the fulfillment offer. The requesting user can also enter additional information about the need request, including acts that may or may not need to occur to discharge the need. The acceptance process executes to store entries by the user and community members collected during this exchange.

In addition, the acceptance process 230 executes to update the needs and fulfillment repository 170, marking need requests and fulfillment offers to reflect their current status (e.g., accepted/rejected.). Accepted fulfillment offers are marked “completed” or “in progress,” for example. Need requests of an “open request” need type, remain displayable to community members even after accepting a fulfillment offer, whereas need requests of different needs types preferably do not.

Once a fulfillment offer is accepted, community members preferably complete the acts agreed upon to discharge the user's need. Off-system acts are completed by the community members without use of system processes. On-system acts, or acts completed with assistance from the system, are carried in whole or in part by the transaction process 240. Accepted fulfillment offers, involving an on-system and/or off-systems acts, forward to the transaction process 240 for proper handling.

The transaction process 240 is operable to process accepted fulfillment offers and requests for content. Doing so, the transaction process records accepted fulfillment offers in the transaction repository 260, populating emails, web logs, calendar appointments, etc. for both on-system and off-system acts discharging the user's need. For on-system acts, the transaction process is operable help discharge all or a portion of the user's need.

To that end, the transaction process 240 is operable to carry out financial transactions, for example. Doing so, the transaction process executes, in a known way, to transfer money from the community member to a designated entity (e.g., the requesting user, third-party, hospital, public service provider, etc.), for example.

In other embodiments, the transaction process executes to provide on-line fundraising activities. The transaction process is thus operable to carry out million pixel page advertisements, for pay advertisements, and auctions for my cause.

One example of million pixel page advertising is “The Million Dollar Homepage.” In a similar manner, the transaction process executes to sell pixels to community members, post-on-line advertisements and forward profits to a designated entity, in a known way.

Carrying out for pay advertisements, the transaction process executes to sell ads to community members to be posted on-line and in traditional mediums, collecting payments for ads sold, and forwarding profits to a designated entity. For pay advertisements are generally known in the art, and as such not described in detail here.

Carrying out auctions for my cause, the transaction process executes an on-line auction for products and services donated by community members. In a known way, the transaction process collects payments for sold products and services, forwarding profits to a designated entity.

In another embodiment, the transaction process executes to provide on-line money lending activities. Such online money lending activities preferably result in a money loan or gift to the requesting user. An example of a money loan system is implemented by Prosper Marketplace, Inc. In a similar manner the transaction process executes to provide on-line loan origination services. In a known way, the transaction process provides a promissory note, or other legal instrument.

It is to be understood therefore that the transaction process 240 is configured in a variety of ways to help discharge the user's need. As the transaction process executes, it stores data to the transaction repository 260, recording accepted offers, and on- and off-system actions.

The transaction repository 260 is preferably a digital storage medium adapted with a database, of a known sort, having a structured collection of records. As noted, the transaction process maintains a record of accepted fulfillment offers, and completed acts discharging a user's need. Such information is accessed by administrators for record keeping and data mining purposes, as desired. The system also apprises other community members of such information via the notify recipients process 250.

Accordingly, the notify recipients process 250 is operable to notify the requesting user, offering community member, and other community members, of the accepted fulfillment offer and acts discharging the user's need. The notify recipients process 250 is also operable to identify and package relevant content for display to the requesting user, offering community member, and other community members.

For these purposes, the notify recipient process 250 is operable by techniques/structures substantially the same as those of the format content for need process 150 noted above, incorporated by reference here for brevity. In a similar manner, the notify recipient process 250 executes to create a display package accessible over the user interface 111 and fulfillment interface 211.

The display package preferably includes the status of the need request (e.g., fully or partially accepted fulfillment offer), as well as information about the offering community member, their fulfillment actions, and additional unfulfilled portions of the need request, if needed. The display package also includes relevant content (e.g., advertising and topic media) for display to users and community members.

It is to be understood that the above processes execute in a variety of sequences and combinations to perform objectives disclosed herein. FIGS. 3-5 provide examples of the relative order and manner of execution of such processes.

FIG. 3 shows one embodiment of the system executing the user login and need request process 110 by the following steps. A requesting user preferably logins and selects “add need” 300. Next, to populate a need request, the requesting user inputs one or more need descriptions 310, summarizing personal need(s) arising from a medical illness or catastrophic event. The requesting user then preferably selects a need type 320, identifying the appropriate category of the need request. The requesting user can also input need properties 330, thus adding additional details about user's specific need. Once input, the need request process 110 prompts the user to review a final need summary 340, showing the above information input by the user. If the need summary is not correct 350, the need request process 110 repeats, allowing the user to edit the need 360. If the need is correct, the need request process 110 is sent to the recipient selection process 130.

FIG. 4 shows one embodiment of the system executing the user login and fulfillment offer process 210, according to the following steps. Over the fulfillment interface 211, a community member can login and select “fulfill need” 400, thereby presenting the community member with a list of needs entered by a requesting user (See FIG. 3). Offering to fulfill one or more of such needs, the community member user selects one or more need requests 410 to fulfill. The offering community member then configures fulfillment data 420, preferably summarizing the actions he will take to fulfill the users need request. The community member next configures comments and/or a response 430, as desired. Next, the community member reviews a final summary of the fulfillment offer 440, opting to edit the fulfillment offer 460 if the fulfillment offer is incorrect 450. Otherwise, if the fulfillment offer is correct 450, the inputs populate the fulfillment offer process 210. Once populated, the fulfillment process 210 and above collected inputs are sent to the acceptance process 230 for processing.

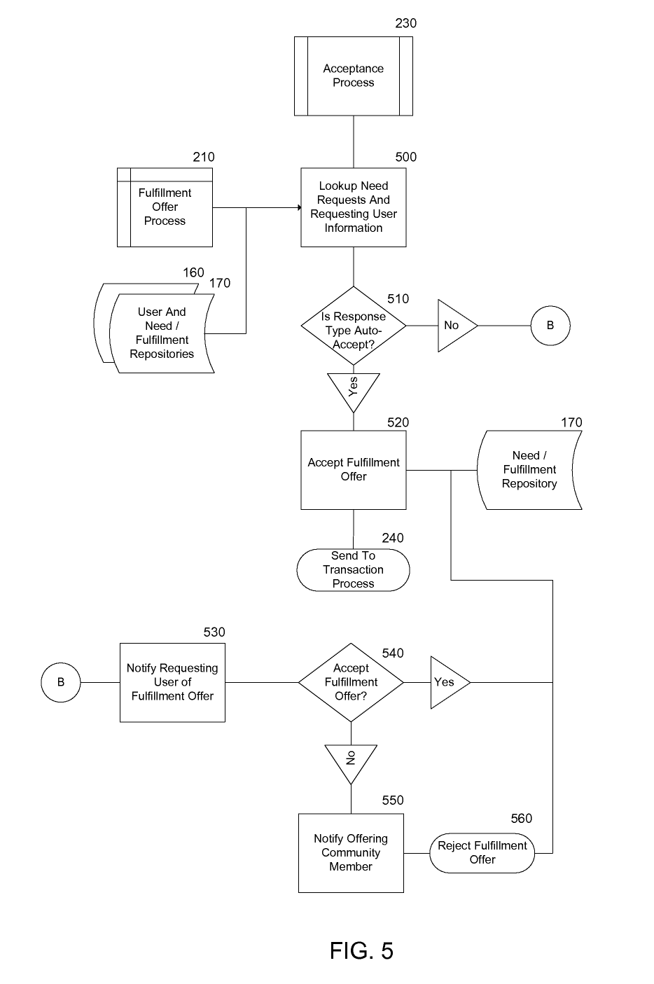

FIG. 5 shows one embodiment of the system executing the acceptance process 230 by the following steps. The fulfillment process 210 invokes the acceptance process 230, populating it with collected input (See FIG. 4). Once invoked, the acceptance process 230 executes to lookup need requests and user information 500 in the user repository 160 and need and fulfillment repository 170 by executing appropriate queries. If the response type is “auto-accept” 510, the acceptance process executes to accept the fulfillment offer 520, marking entries in the need request and fulfillment offer repository 170 accordingly. The accepted fulfillment offer is then sent to the transaction process 240 to fulfill the user need request. If the response type is not set to “auto-accept,” the requesting user is notified of the fulfillment offer 530. At this point, the requesting user has the option to accept or decline the fulfillment offer. If the requesting user accepts the fulfillment offer 540, then the acceptance process marks entries in the need request and fulfillment offer repository 170 accordingly. If the requesting user does not accept the fulfillment offer 540, the acceptance process notifies the offering community member 550 that the requesting user rejected the fulfillment offer 560, updating the need and fulfillment repository 170 accordingly.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A system comprising:
a need request engine operable to receive a need request from a user and present the received need request to a plurality of community members of the user; and
a fulfillment engine operable to receive a plurality of fulfillment offers to the need request from at least one of the plurality of community members, presenting the fulfillment offers to the user, and receiving an acceptance of the fulfillment offer by the user.

2. The system of claim 1 wherein the need request engine is operable to receive a need request arising from a medical illness.

3. The system of claim 1 wherein the need request engine is operable to receive a need request arising from a personal catastrophe.

4. The system of claim 1 wherein the fulfillment engine is operable to receive a fulfillment offer in the format of a fundraising activity.

5. The system of claim 1 wherein the fulfillment engine is operable to receive a fulfillment offer in the format of a money loan.

6. The system of claim 1 wherein the fulfillment engine is operable to receive an offer in the format of one or more physical actions by the community member.

7. A system comprising:
a need request engine operable to receive a need request from a user and present the received need request to a plurality of community members of the user;
wherein the need request engine is operable to identify relevant content based at least in part upon said need request and present the relevant content to a plurality of community members of the user.

8. The system of claim 7 further comprising:
a fulfillment engine operable to receive a plurality of fulfillment offers to the need request from at least one of the plurality of community members, presenting the fulfillment offers to the user, and receiving an acceptance of the fulfillment offer by the user.

9. The system of claim 8 wherein the fulfillment engine is operable to receive a selection of relevant content from at least one of the plurality of community member.

10. A method comprising:
receiving a need request from a user;
setting up response types desired for the need request;
formatting the need request and presenting the need request to a plurality of community members of the user;
receiving a plurality of fulfillment offers to the need request from plurality of community members;
receiving an acceptance of a fulfillment offer from one of the plurality of community members by the user;
notifying the acceptance to the community member who offered the accepted fulfillment offer, and to the rest of the community members receiving the need request; and
processing a resulting transaction of the accepted fulfillment offer.

11. The method of claim 10, wherein the need request is in a format selected from the group comprising of blog entries, calendar appointments, emails, text messages, and voice messages.

12. The method of claim 10, wherein the fulfillment offer is in a format selected from the group comprising of blog entries, calendar appointments, emails, text messages, and voice messages.

13. The method of claim 10, wherein the resulting transaction is in a format selected from the group comprising of financial transactions, calendar appointments, blog postings, million pixel page advertisements, for pay advertisements, emails, and auctions for my cause.
